(19) United States
(12) Patent Application Publication
(10) Pub. No.: US 2018/0254676 A1
(43) Pub. Date: Sep. 6, 2018

(54) PERMANENT-MAGNET-EMBEDDED ELECTRIC MOTOR, COMPRESSOR, AND REFRIGERATION AND AIR-CONDITIONING APPARATUS

(71) Applicant: Mitsubishi Electric Corporation, Tokyo (JP)

(72) Inventors: Masahiro NIGO, Tokyo (JP); Kazuchika TSUCHIDA, Tokyo (JP)

(73) Assignee: Mitsubishi Electric Corporation, Tokyo (JP)

(21) Appl. No.: 15/759,871

(22) PCT Filed: Jan. 7, 2016
(86) PCT No.: PCT/JP2016/050360

§ 371 Date: Mar. 14, 2018

(51) Int. Cl. H02K 1/27; H02K 1/02; F04C 18/344; F25B 31/02

(52) U.S. Cl. CPC H02K 1/2766; H02K 1/02; F04C 2240/40; F25B 31/026; F04C 18/344

(57) ABSTRACT

A permanent-magnet-embedded electric motor includes an annular stator, and an annular rotor iron core disposed on an inner side of the stator and having a plurality of magnet insertion holes aligned in a circumferential direction of the stator. Each of the magnet insertion holes has a pair of recess portions on an outer side surface in the radial direction of the stator, the pair of recess portions are respectively disposed on one end portion and on another end portion of the outer side surface in the circumferential direction of the stator, and a plurality of permanent magnets respectively inserted in the magnet insertion holes. Each of the recess portions has a depth of from 10% to 40% of the thickness of each of the permanent magnets in the radial direction of the stator.

### CROSS REFERENCE TO RELATED APPLICATION

This application is a U.S. national stage application of International Patent Application No. PCT/JP2016/050360 filed on Jan. 7, 2016, the disclosure of which is incorporated herein by reference.

### TECHNICAL FIELD

The present invention relates to a permanent-magnet-embedded electric motor including a stator and a rotor disposed on an inner side of the stator, to a compressor, and to a refrigeration and air-conditioning apparatus.

### BACKGROUND

In a permanent-magnet-embedded electric motor having magnet insertion holes each formed in a shape projecting radially inwardly, the magnets and the magnet insertion holes are arranged so that the side end portions thereof are close to the outer circumferential surface of the rotor (hereinafter referred to simply as “rotor outer circumferential surface”). The side end portions of the magnets and of the magnet insertion holes close to the rotor circumference have a lower magnetic permeability than the magnetic permeability in a portion of the iron core at the magnetic pole center, and thus, the magnetic flux generated by the stator coil is not easily linked in these side end portions. Accordingly, the magnetic flux generated during the energization of the stator tends to concentrate in portions of the rotor iron core adjacent to the side end portions of the magnet insertion holes. A higher magnetic flux generated by a stator coil may lead to higher demagnetization in the side end portions of the permanent magnet disposed close to those portions of the rotor iron core.

In the motor of Patent Literature 1, the magnets and the magnet insertion holes are arranged, in each of the magnetic poles, to project toward the inner circumferential surface of the rotor when viewed in the axial direction of the rotor. The edge portions of the magnets each have a width that decreases toward the end. In addition, each of the edge portions of the magnets has a cutout in a portion closer to the centerline of that magnetic pole. The motor of Patent Literature 1 has been designed, by the formation of such cutout, to reduce the portions of the magnets that are easily demagnetized. That is, the motor of Patent Literature 1 has been designed to reduce variation in the intensity of magnetic flux, and to thus mitigate the reduction in motor performance, by configuring the magnets not to be easily demagnetized.

### PATENT LITERATURE

Patent Literature 1: Japanese Patent Application Laid-open No. 2013-212035

However, the motor disclosed in Patent Literature 1 has the cutouts in portions of the magnets that are easily demagnetized. Thus, the motor disclosed in Patent Literature 1 includes magnets having a reduced size, thereby resulting in a reduction in the amount of the magnetic flux generated by each magnet. This presents another problem in that a small-sized high efficiency motor is difficult to produce.

### SUMMARY

The present invention has been made in view of the foregoing, and it is an object of the present invention to provide a permanent-magnet-embedded electric motor capable of avoiding reduction in the amounts of the magnetic flux of the permanent magnets, while still achieving high efficiency.

In order to solve the problem and to achieve the object described above, a permanent-magnet-embedded electric motor of the present invention includes: an annular stator; an annular rotor iron core disposed on an inner side of the stator and having a plurality of magnet insertion holes aligned in a circumferential direction of the stator, a sectional shape of each of the magnet insertion holes being a shape projecting toward a center of the stator, each of the magnet insertion holes having a pair of recess portions on an outer side surface in a radial direction of the stator, the recess portions of each of the magnet insertion holes being respectively disposed on one end portion and on another end portion of the outer side surface, the one end portion and the another end portion being aligned in the circumferential direction of the stator; and a plurality of permanent magnets respectively inserted in the magnet insertion holes. The recess portions of the permanent-magnet-embedded electric motor of the present invention each have a depth of from 10% to 40% of a thickness of each of the permanent magnets in the radial direction of the stator.

A permanent-magnet-embedded electric motor according to the present invention provides an advantage in that reduction in the amounts of the magnetic flux of the permanent magnets is avoided, while high efficiency is still achieved.

### BRIEF DESCRIPTION OF DRAWINGS

FIG. 1 is a view illustrating a cross section orthogonal to the rotational centerline of a permanent-magnet-embedded electric motor according to a first embodiment of the present invention.

FIG. 2 is an enlarged view illustrating the rotor illustrated in FIG. 1.

FIG. 3 is an enlarged view illustrating one of the permanent magnets and one of the magnet insertion holes illustrated in FIG. 2.

FIG. 4 is a view illustrating the magnet insertion hole illustrated in FIG. 3 having no permanent magnet inserted therein.

FIG. 5 is a view for illustrating dimensions of some portions of the magnet insertion hole illustrated in FIG. 4.

FIG. 6 is a view illustrating a first rotor iron core having no recess portions in the magnet insertion holes.

FIG. 7 is a view for illustrating one advantage of the permanent-magnet-embedded electric motor according to the first embodiment of the present invention.

FIG. 8 is a view for illustrating another advantage of the permanent-magnet-embedded electric motor according to the first embodiment of the present invention.

FIG. 9 is a view illustrating a second rotor iron core having inappropriately formed recess portions in the magnet insertion holes.

FIG. 10 is a chart illustrating a relationship between the induced voltage before the conduction of demagnetization current and the D/T ratio.

FIG. 11 is a chart illustrating a relationship between the induced voltage after the conduction of demagnetization current and the D/T ratio.

FIG. 12 is a view illustrating a variation of the rotor illustrated in FIG. 1.

FIG. 13 is a longitudinal cross-sectional view of a compressor according to a second embodiment of the present invention.

FIG. 14 is a diagram illustrating a refrigeration and air-conditioning apparatus according to a third embodiment of the present invention.

### DETAILED DESCRIPTION

A permanent-magnet-embedded electric motor, a compressor, and a refrigeration and air-conditioning apparatus according to embodiments of the present invention will be described in detail below on the basis of the drawings. Note that these embodiments are not intended to limit the scope of the present invention.

### First Embodiment

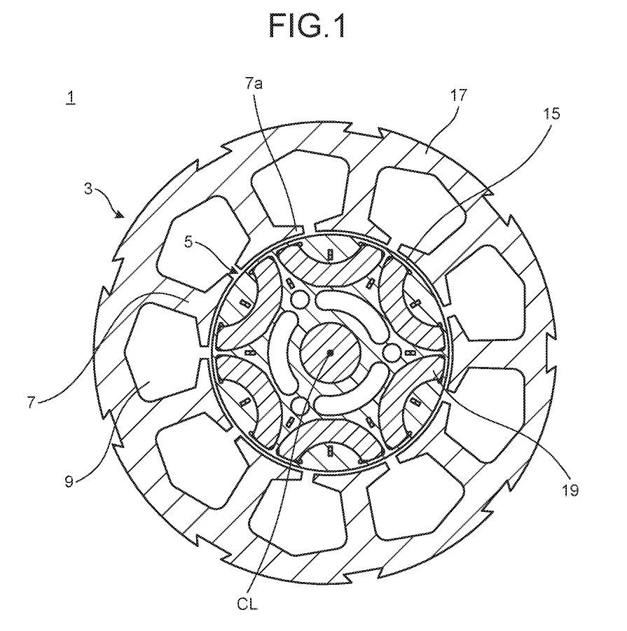

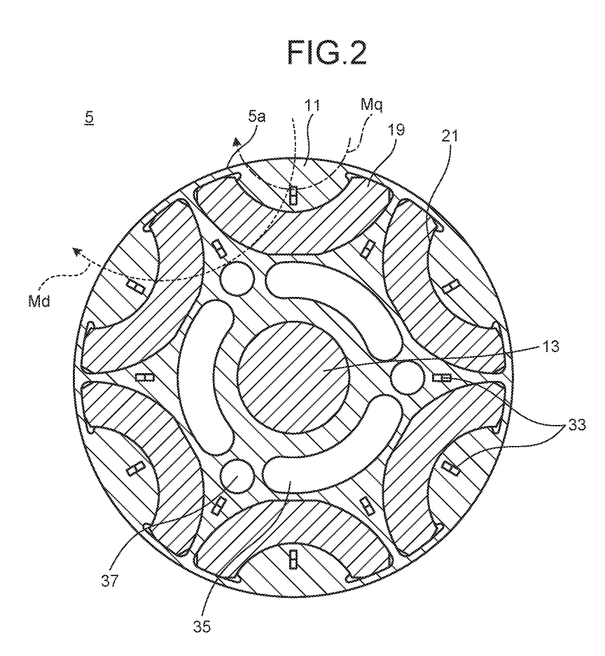

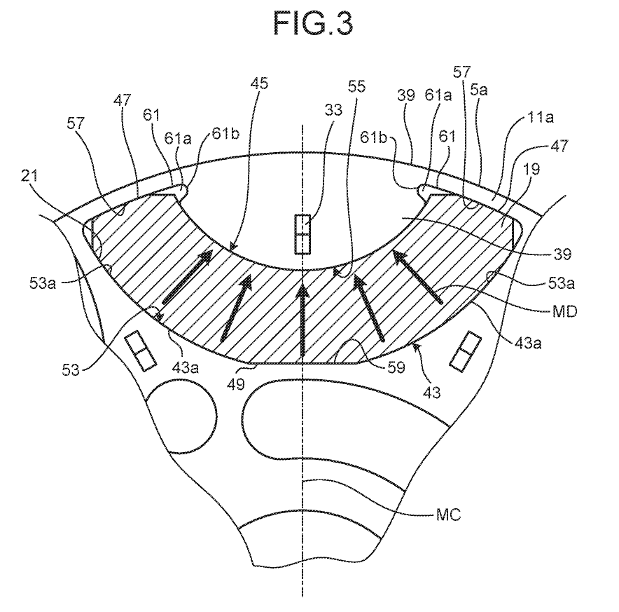

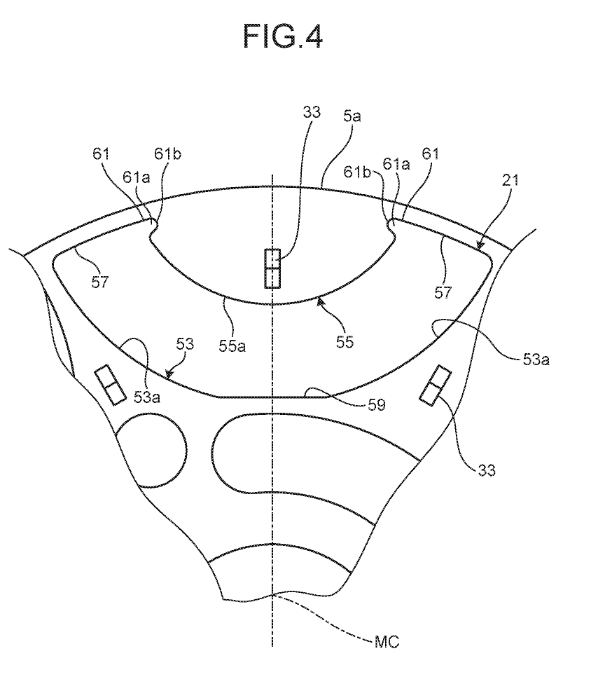

FIG. 1 is a view illustrating a cross section orthogonal to the rotational centerline of a permanent-magnet-embedded electric motor according to a first embodiment of the present invention. FIG. 2 is an enlarged view illustrating the rotor illustrated in FIG. 1. FIG. 3 is an enlarged view illustrating one of the permanent magnets and one of the magnet insertion holes illustrated in FIG. 2. FIG. 4 is a view illustrating the magnet insertion hole illustrated in FIG. 3 having no permanent magnet inserted therein.

The permanent-magnet-embedded electric motor 1 includes a stator 3, and a rotor 5 disposed rotatably inside the stator 3.

The stator 3 includes an annular stator iron core 17, and a plurality of teeth portions 7 circumferentially arranged equidistantly inside the stator iron core 17.

The teeth portions 7 each project from the stator iron core 17 toward the rotational centerline CL, and are thus formed radially. The stator 3 has a slot portion 9 formed in a space between each pair of adjacent teeth portions 7.

Each of the teeth portions 7 is disposed adjacent to another one of the teeth portions 7 with a corresponding slot portion 9 interposed therebetween. The teeth portions 7 and the slot portions 9 are circumferentially arranged alternately and equidistantly.

A stator winding heretofore known (not illustrated) is wound around each of the teeth portions 7 in a known manner.

The rotor 5 includes a rotor iron core 11 and a shaft 13.

The shaft 13 is fixed in a center axis portion of the rotor iron core 11 by shrink fitting, cooling fitting, or press fitting to transmit rotational energy to the rotor iron core 11.

A clearance 15 is provided between the outer circumferential surface of the rotor iron core 11 and the inner circumferential surface of the stator 3.

In this configuration, the rotor 5 is held rotatably about the rotational centerline CL inside the stator 3 with the clearance 15 interposed therebetween. Conduction of a current having a frequency in synchronization with the specified rotational speed to the stator 3 causes a rotating magnetic field to be generated. This rotating magnetic field causes the rotor 5 to rotate. The clearance 15 between the stator 3 and the rotor 5 has a dimension from 0.3 mm to 1.0 mm.

The configuration of the stator 3 and the rotor 5 will next be described in detail.

The stator iron core 17 is produced by punching out electromagnetic steel sheets each having a thickness from about 0.1 mm to 0.7 mm and having a predetermined shape, and fixing together by swaging to stack a predetermined number of electromagnetic steel sheets. Herein, electromagnetic steel sheets each having a sheet thickness of 0.35 mm are used.

A major part of each of the teeth portions 7 has generally a constant circumferential width from the radially outer end portion to the radially inner end portion, while a tooth tip portion 7a is formed in an edge (i.e., most radially inward) portion of each of the teeth portions 7.

The tooth tip portions 7a each have an umbrella-like shape in which both side portions thereof extend circumferentially.

A stator winding is wound on each of the teeth portions 7 to form a coil to generate a rotating magnetic field. FIGS. 1 to 4 omit illustrating the coils and the stator windings.

The coil is formed by winding a magnet wire directly on each of the teeth portions 7 having an electrical insulator interposed therebetween. This winding technique is referred to as concentrated winding. The coils are connected in a three-phase Y configuration. The number of turns and the wire diameter of each coil are determined depending on required characteristics, voltage specification, and the cross-sectional area of each slot. The required characteristics are the rotational speed and the torque.

Herein, divided teeth are extended in a band shape for easy winding, and a magnet wire having a wire diameter ø of about 1.0 mm is then wound onto the teeth portion 7 of each magnetic pole to form a coil having about 80 turns. After the winding, the divided teeth are rounded into an annular shape, and the facing ends are welded together to form the stator 3.

The shaft 13 held rotatably is disposed substantially at the center of the stator 3. The rotor iron core 11 is fitted around the shaft 13.

Similarly to the stator iron core 17, the rotor iron core 11 is produced by punching out electromagnetic steel sheets each having a thickness from about 0.1 mm to 0.7 mm and having a predetermined shape, and fixing together by swaging to stack a predetermined number of electromagnetic steel sheets. Herein, electromagnetic steel sheets each having a sheet thickness of 0.35 mm are used.

The rotor 5 is of the embedded magnet type. A plurality of permanent magnets 19 are disposed in the rotor iron core 11, and are magnetized so that a north (N) pole and a south (S) pole occur alternately. In the first embodiment, the number of the permanent magnets 19 is six.

The permanent magnets 19 each have a curved, arc shape in a cross section normal to the rotational centerline CL of the rotor 5. The permanent magnets 19 are each arranged so that the arc shape of that permanent magnet 19 projects toward the center of the rotor 5. The permanent magnets 19 are each curved symmetrically about the magnetic pole centerline MC of the corresponding magnetic pole.

A more detailed description is provided below. In the rotor iron core 11, as many magnet insertion holes 21 as a number corresponding to the permanent magnets 19 are formed. The magnet insertion holes 21 each have a corresponding one of the permanent magnets 19 inserted therein. One permanent magnet 19 is inserted in one magnet insertion hole 21.

Note that the first embodiment uses a six-pole rotor by way of example, but the number of magnetic poles of the rotor 5 may be any number as far as it is two or more. Herein, a ferrite magnet is used as each of the permanent magnets 19 (hereinafter the singular form “the permanent magnet 19” may also be used for convenience). The permanent magnet 19 is formed so that the inner circumferential surface and the outer circumferential surface of that ferrite magnet are certain concentric arcs, and the permanent magnet 19 has a thickness T of uniformly about 6 mm.

The thickness T of the permanent magnet 19 is defined as the maximum magnet thickness of the thickness from the hole outer side surface 55 (i.e., radially outer side surface) of a magnet insertion hole 21 to a hole inner side surface 53 (i.e., radially inner side surface) of that magnet insertion hole 21.

As illustrated in FIG. 3, the permanent magnet 19 is a magnet having a magnetic field MD radially oriented about the center of the concentric arcs. Note that the magnet may be a rare earth magnet mainly containing, for example, neodymium, iron, and boron.

Each of the magnet insertion holes 21 (hereinafter the singular form “the magnet insertion hole 21” may also be used for convenience) has a cross-sectional shape identical to the shape of the permanent magnet 19. That is, the magnet insertion hole 21 has a circumferential length greater than the radial length of the magnet insertion hole 21. The magnet insertion hole 21 has a cross-sectional shape projecting toward the center of the stator 3.

A swage 33 is provided on the magnetic pole centerline MC to secure the stack in a portion of the iron core radially outward from the magnet insertion hole 21 of the rotor 5, and thus curbs deformation during manufacturing.

The rotor iron core 11 has a plurality of air holes 35 and a plurality of rivet holes 37 alternately and equidistantly arranged circumferentially at locations radially inward from the magnet insertion holes 21.

A swage 33 is also provided between a rivet hole 37 and a pair of magnet insertion holes 21.

The permanent magnet 19 and the magnet insertion hole 21 will next be described in detail.

The permanent magnet 19 and the magnet insertion hole 21 are each formed in a shape symmetric about the magnetic pole centerline MC when viewed in a cross section normal to the rotational centerline CL of the rotor 5.

The permanent magnet 19 has an inner side surface 43, an outer side surface 45, and a pair of edge side surfaces 47 when viewed in a cross section normal to the rotational centerline CL of the rotor 5. Note that the terms “inner” and “outer” respectively in the designations “inner side surface 43” and “outer side surface 45” are used to indicate the relatively radially inner and outer positions when viewed in a cross section normal to the rotational centerline CL.

The magnet insertion hole 21 has, in the boundary geometry thereof, the hole inner side surface 53, a hole outer side surface 55, and a pair of hole edge side surfaces 57 when viewed in a cross section normal to the rotational centerline CL of the rotor 5. Note that the terms “inner” and “outer” respectively in the designations “hole inner side surface 53” and “hole outer side surface 55” are also used to indicate the relatively radially inner and outer positions when viewed in a plane normal to the rotational centerline CL.

The outer side surface 45 of the permanent magnet 19 is mostly formed of a first arc surface defined by a first arc radius.

Similarly, the hole outer side surface 55 of the magnet insertion hole 21 is mostly formed of a first arc surface 55a defined by the first arc radius. The portion between the rotor outer circumferential surface 5a and the first arc surface 55a of the rotor iron core 11 is defined as an iron core outer portion 39.

Meanwhile, the inner side surface 43 of the permanent magnet 19 is formed of a second arc surface 43a defined by a second arc radius greater than the first arc radius, and of a flat surface 49.

Similarly, the hole inner side surface 53 of the magnet insertion hole 21 is formed of a second arc surface 53a defined by the second arc radius, and a flat surface 59.

Note that the magnet insertion hole 21 and the permanent magnet 19 have a relationship that the permanent magnet 19 is inserted in the magnet insertion hole 21. Therefore, the first arc radius and the second arc radius in association with the magnet insertion hole 21, and the first arc radius and the second arc radius in association with the permanent magnet 19 are not respectively the same in a strict sense. However, considering the relationship that the permanent magnet 19 is inserted in the magnet insertion hole 21, the same terms are used herein, for simplicity of illustration, for those of the permanent magnet 19 and for those of the magnet insertion hole 21.

The first arc radius and the second arc radius share a common radius center. The shared common radius center is located radially outward from the corresponding permanent magnet 19 and from the corresponding magnet insertion hole 21, and located on the corresponding magnetic pole centerline MC.

In other words, the inner side surface 43 and the outer side surface 45 are concentric with each other, and the center of the first arc surface and the center of the second arc surface coincide with the center of the magnetic field orientation, i.e., the focal point of the magnetic field orientation, of that permanent magnet 19. Similarly, the hole inner side surface 53 and the hole outer side surface 55 are concentric with each other, and the center of the first arc surface and the center of the second arc surface coincide with the focal point of the magnetic field orientation of that permanent magnet 19. In FIG. 3, the arrows of the reference symbol MD schematically illustrate the orientation directions.

Note that the arc shapes of the magnet insertion hole 21 and of the permanent magnet 19 are merely examples. The permanent-magnet-embedded electric motor 1 of the first embodiment is not limited to using a rotor including the magnet insertion holes 21 and the permanent magnets 19 generally having arc shapes, but may broadly include a rotor including magnet insertion holes and permanent magnets having shapes projecting toward the rotor.

The flat surface 49 and the flat surface 59 each extend along a direction orthogonal to the magnetic pole centerline MC when viewed in a cross section normal to the rotational centerline CL of the rotor 5.

Each of the pair of edge side surfaces 47 joins together the edge portions facing each other of the inner side surface 43 and of the outer side surface 45. Each of the pair of hole edge side surfaces 57 joins together the edge portions facing each other of the hole inner side surface 53 and of the hole outer side surface 55.

The hole outer side surface 55 of the magnet insertion hole 21 includes the first arc surface 55a constituting a most part of the hole outer side surface 55, and a pair of recess portions 61.

One recess portion 61 of the pair of recess portions 61 is located on one end side of the first arc surface 55a of the hole outer side surface 55, while the other recess portion 61 of the pair of recess portions 61 is located on another end side of the first arc surface 55a of the hole outer side surface 55. In the illustrated example, each of the pair of recess portions 61 is disposed between the adjacent one of the hole edge side surfaces 57 and the hole outer side surface 55.

Each of the pair of recess portions 61 extends toward a circumferentially central portion of the iron core outer portion 39, i.e., toward the magnetic pole centerline MC. A bottom portion 61b of each of the pair of recess portions 61 is formed in an arc shape.

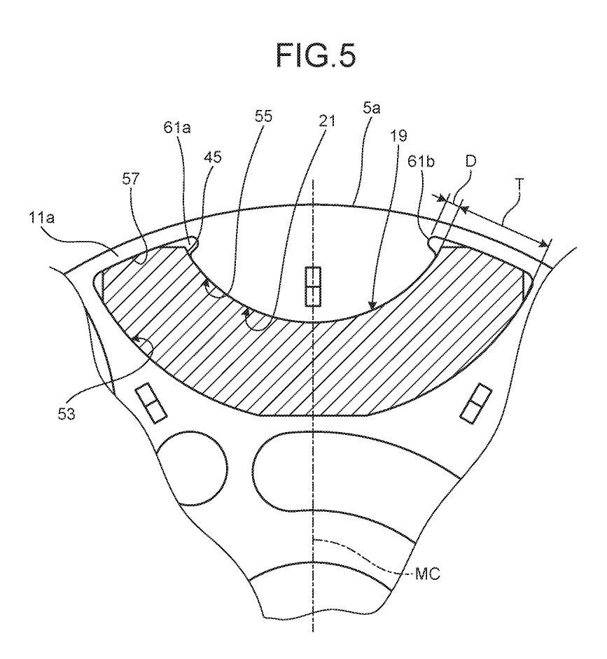

FIG. 5 is a view for illustrating dimensions of some portions of the magnet insertion hole illustrated in FIG. 4. In a state the permanent magnet 19 is inserted in the magnet insertion hole 21, the recess portions 61 of the magnet insertion hole 21 and the outer side surface 45 of the permanent magnet 19 are significantly spaced apart from each other. A gap 61a, which is a non-magnetic region, is formed between each of the recess portions 61 and the outer side surface 45. The gap 61a is a space enclosed by the inner circumferential surface of the corresponding recess portion 61 and the outer side surface 45.

Each of the recess portions 61 (hereinafter the singular form “the recess portion 61” may also be used for convenience) has a depth D less than the thickness T of the permanent magnet 19. For example, if the thickness T of the permanent magnet 19 is 6 mm, the depth D of the recess portion 61 is 1 mm. The D/T ratio in this configuration is 16.7%.

If the outer side surface 45 of the permanent magnet 19 exists facing the recess portion 61 when the permanent magnet 19 is inserted in the magnet insertion hole 21, the depth D of the recess portion 61 represents the distance between the bottom portion 61b of the recess portion 61 and the outer side surface 45 of the permanent magnet 19.

Note that, if the edge portion of the permanent magnet 19 has a cut-out or beveled portion, the depth D of the recess portion 61 represents the distance between the bottom portion 61b of the recess portion 61 and the outer side surface of the permanent magnet 19 in a region excluding the cut-out or beveled portion.

In addition, if no outer side surface of the magnet exists facing the recess portion 61 due to use of a permanent magnet shorter than the permanent magnet 19 of the illustrated example, the depth D of the recess portion 61 represents the distance from an imaginary surface generated by extending the outer side surface of the magnet to the point facing the recess portion 61 to the bottom portion 61b of the recess portion 61.

Note that, if the edge portion of the permanent magnet 19 has a cut-out or beveled portion, the thickness T of the permanent magnet 19 represents the thickness in a region excluding the cut-out or beveled portion.

The hole edge side surface 57 of the magnet insertion hole 21 is disposed in a vicinity of the rotor outer circumferential surface 5a. A side edge thin portion 11a having a constant thickness exists between the hole edge side surface 57 of the magnet insertion hole 21 and the rotor outer circumferential surface 5a. The side edge thin portion 11a serves as a path for short-circuit magnetic flux between adjacent magnetic poles, and thus preferably has as low a thickness as practically possible. Herein, based on a minimum width achievable by press working, this thickness is determined as about 0.35 mm, which is comparable to the sheet thickness of the electromagnetic steel sheets.

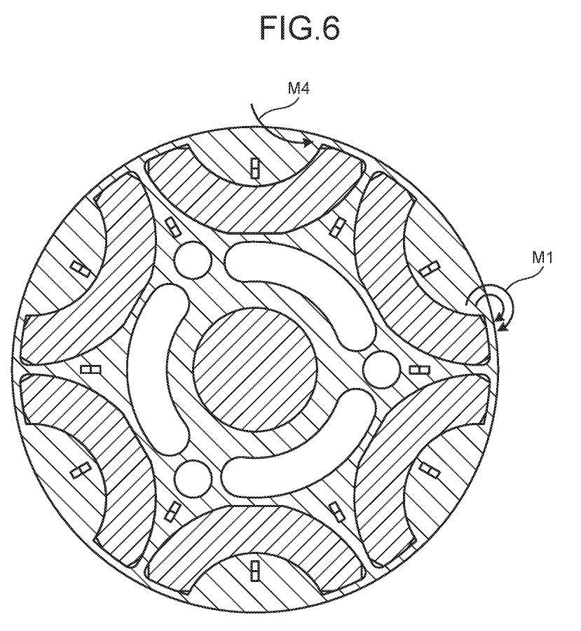

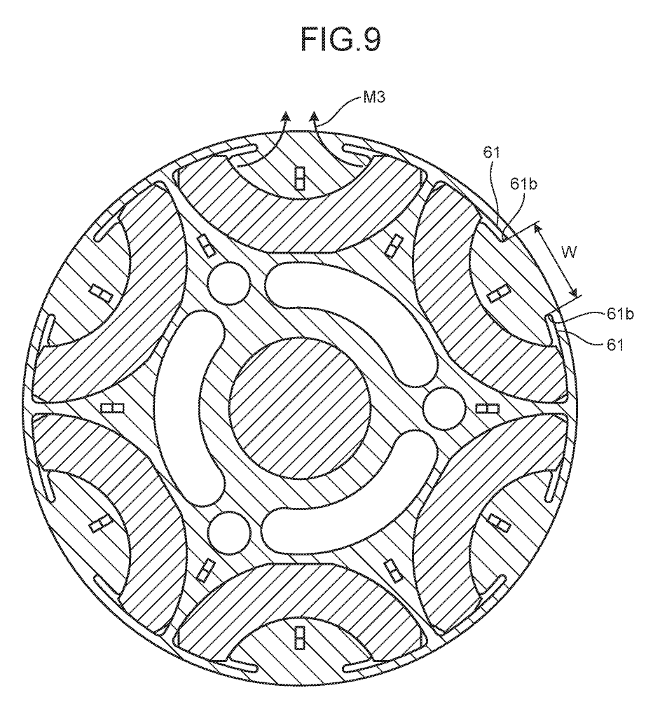

Next, with reference to a first rotor iron core illustrated in FIG. 6 and a second rotor iron core illustrated in FIG. 9, actions of the permanent-magnet-embedded electric motor 1 of the first embodiment will be described.

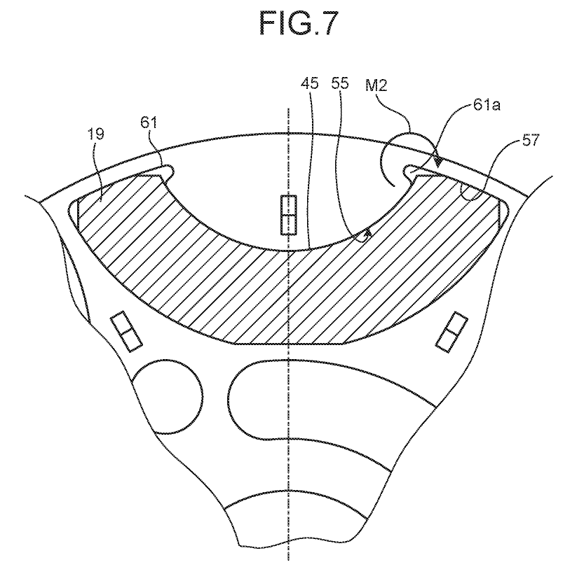

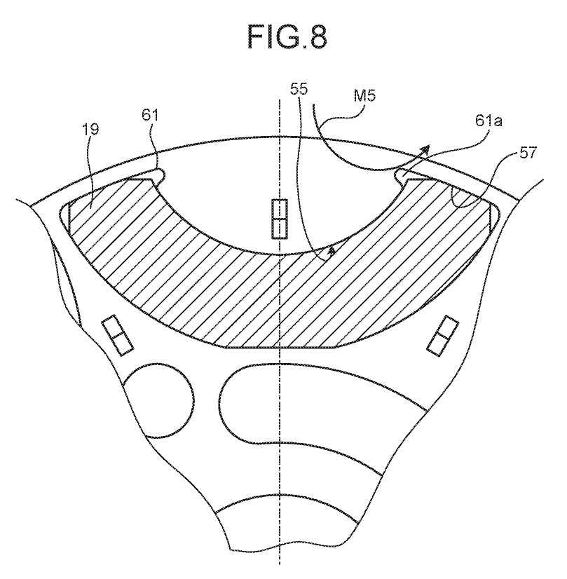

FIG. 6 is a view illustrating a first rotor iron core having no recess portions in the magnet insertion holes. FIG. 6 corresponds to FIG. 2. FIG. 7 is a view for illustrating one advantage of the permanent-magnet-embedded electric motor according to the first embodiment of the present invention. FIG. 8 is a view for illustrating another advantage of the permanent-magnet-embedded electric motor according to the first embodiment of the present invention. FIG. 9 is a view illustrating a second rotor iron core having inappropriately formed recess portions in the magnet insertion holes. FIG. 9 corresponds to FIG. 2.

In the first rotor iron core illustrated in FIG. 6, no recess portions are formed in the edge portions of the hole outer side surface of each of the magnet insertion holes. In this case, a rotor having permanent magnet insertion holes each having a shape projecting toward the center of the rotor has a configuration in which, in particular, the boundary portion between the hole outer side surface and the hole edge side surface is close to the magnet. Accordingly, a magnetic flux M1 generated from the magnet surface tends to be short-circuited to the side surface of the magnet. In the example of FIG. 6, the magnetic flux M1 generated from the radially outer side surface of the permanent magnet is short-circuited to the edge side surface of the permanent magnet.

In contrast, the recess portions 61 are formed in the first embodiment as illustrated in FIG. 7. This configuration provides the gap 61a in each boundary portion between the hole outer side surface 55 and the hole edge side surface 57. Thus, as illustrated in FIG. 7, a magnetic flux M2 generated from the magnet surface is hard to be short-circuited to the side surface of the magnet. That is, the magnetic flux M2 generated from the outer side surface 45 of the permanent magnet 19 is hard to be short-circuited to the edge side surface of the permanent magnet 19. Thus, this configuration can increase the amount of effective magnetic flux linking the stator 3 illustrated in FIG. 1.

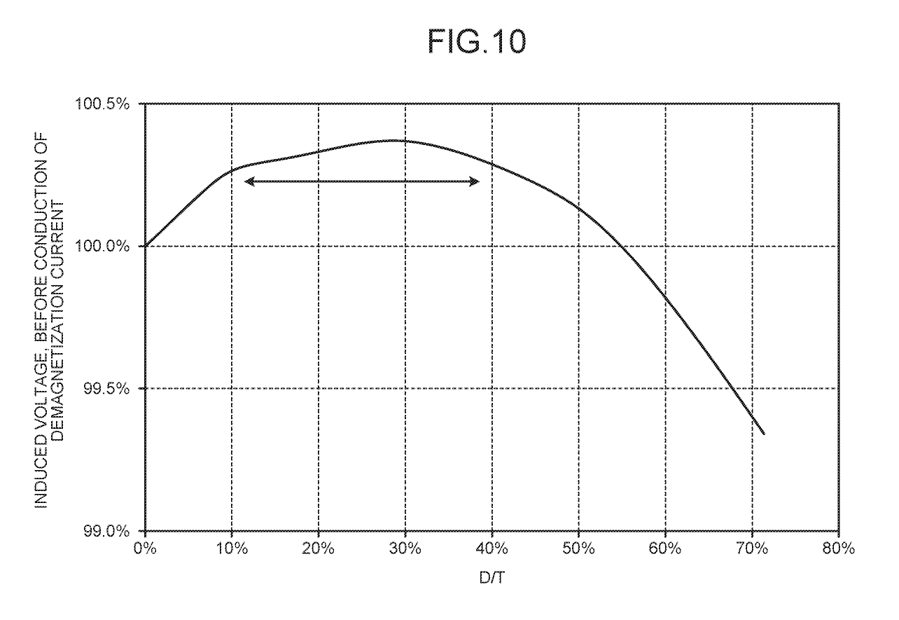

However, on the other hand, excessively deep recess portions, such as those of the second rotor iron core illustrated in FIG. 9, will result in a narrow opening width W that allows a magnetic flux M3 to flow out of the rotor, thereby reducing the amount of the magnetic flux linking the stator. The opening width W is equivalent to the distance between the bottom portion 61b of one recess portion 61 of a pair of recess portions 61 and the bottom portion 61b of the other recess portion 61 of that pair of recess portions 61. That is, the second rotor iron core suffers from a problem in that the recess portions 61 hinder the magnetic flux M3 flowing from the rotor to the stator, thereby causing reduction of the induced voltage. This will be described below with reference to FIG. 10.

FIG. 10 is a chart illustrating a relationship between the induced voltage before the conduction of demagnetization current and the D/T ratio. FIG. 10 illustrates a graph of an induced voltage characteristic against a change in the D/T ratio before conduction of a demagnetization phase current to the rotor. The horizontal axis represents the D/T ratio, and the vertical axis represents the induced voltage before conduction of a demagnetization current. The induced voltage in FIG. 10 is a value relative to the induced voltage at the D/T ratio of 0%, being defined as 100%, meaning that no recess portions are formed.

An induced voltage is a voltage generated by a magnetic flux linking from the rotor to the stator when the rotor is rotating. The amount of effective magnetic flux linking to the stator can be evaluated by the value of induced voltage.

As illustrated in FIG. 10, a deep recess portion having, for example, a D/T ratio of 40% or higher hinders the magnetic flux flowing from the rotor to the stator, thereby significantly reducing the induced voltage.

In contrast, use of a D/T ratio of from 10% to 40% in the first embodiment can reduce or eliminate the magnetic flux leaking from an edge portion of the permanent magnet 19, and thus increases the induced voltage as compared to when no recess portions are formed, that is, when the D/T ratio is 0%.

In addition, returning to FIG. 6, if no recess portions are formed as in the case of the first rotor iron core, a rotor having magnet insertion holes each having a shape projecting toward a center of the rotor has a lower magnetic permeability in each edge portion of the magnets and of the magnet insertion holes close to the rotor circumference than in a portion of the iron core at the magnetic pole center. An edge portion close to the rotor circumference refers to a portion such as, for example, the edge side surface 47 or the hole edge side surface 57 of the first embodiment.

Therefore, the magnetic flux M4 generated by the stator coil is hard to link there. Thus, the magnetic flux during energization of the stator tends to concentrate in portions of the iron core between the edge portions of the magnet insertion holes close to the rotor circumference, and the rotor circumference. An increase of the magnetic flux M4 generated by the stator coil causes the edge portions of the permanent magnets in such portions of the iron core to be easily demagnetized. An edge portion of a permanent magnet refers to a portion such as, for example, the edge side surface 47 of the first embodiment.

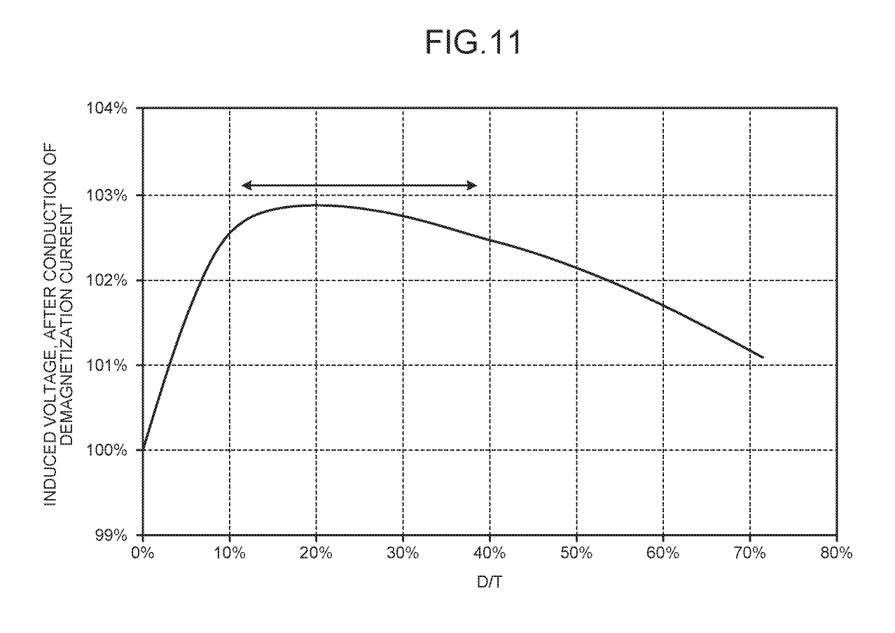

In contrast, the recess portions 61 are formed in the first embodiment as illustrated in FIG. 8. This configuration provides the gap 61a in each boundary portion between the hole outer side surface 55 and the hole edge side surface 57. Thus, as illustrated in FIG. 8, the rotor can be configured such that a magnetic flux M5 generated by the stator coil is not easily linked to the edge portion of the permanent magnet 19, which is thus not easily demagnetized. This will be described below with reference to FIG. 11.

FIG. 11 is a chart illustrating a relationship between the induced voltage, after the conduction of demagnetization current, and the D/T ratio. FIG. 11 illustrates a graph of an induced voltage characteristic against a change in the D/T ratio after conduction of a demagnetization phase current to the rotor. The horizontal axis represents the D/T ratio, and the vertical axis represents the induced voltage after conduction of a demagnetization current. The induced voltage in FIG. 11 is a value relative to the induced voltage at the D/T ratio of 0%, being defined as 100%, meaning that no recess portions are formed.

As can be seen from FIG. 11, when the recess portions are formed degree of demagnetization decreases and induced voltage increases as compared to when no recess portions are formed, that is, when the D/T ratio is 0%.

Meanwhile, a deep recess portion having, for example, a D/T ratio of 40% or higher will hinder the magnetic flux flowing from the rotor to the stator similarly to the case of FIG. 10, and will thus reduce the induced voltage.

Accordingly, the D/T ratio is preferably in a range from 10% to 40%. That is, in the first embodiment, a D/T ratio of from 10% to 40% can increase the induced voltage, and can thus increase the efficiency and reliability, both before and after the conduction of a demagnetization current as compared to when no recess portions are formed.

By increasing the induced voltage as described above, the motor current required for generating the same torque can be reduced, thereby the copper loss in the coils of the motor and the power loss in the inverter can be reduced. Thus, a motor and a compressor having high efficiency can be provided.

Moreover, an increase in the induced voltage enables a motor to be designed to provide an output similar to that of a conventional motor even when the volume of the magnets used in the motor and the volume of the motor are reduced. Therefore, a small-sized motor can be provided.

Furthermore, an improvement in the demagnetization characteristic enables the motor to be configured not to be demagnetized even upon conduction of a current higher than a conventional current to the motor. This can improve the reliability of a compressor such as one described below, and can also expand the operational range. In particular, such configuration is advantageous to a ferrite magnet having a low magnetic coercive force, and to a rare earth magnet for use in a high temperature environment. Note that a rare earth magnet has a characteristic such that the magnetic coercive force decreases in a high temperature environment.

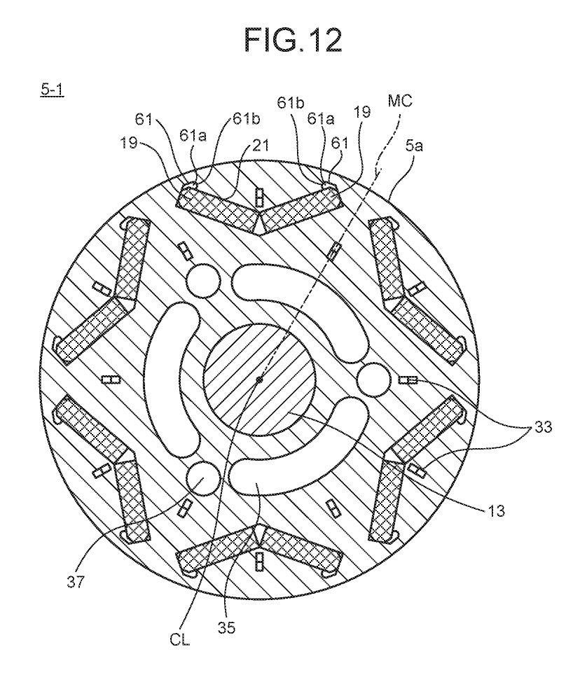

Although the first embodiment has been described in terms of an example to use the magnet insertion holes 21 and the permanent magnets 19 each having an arc shape, magnet insertion holes and permanent magnets each having a linear shape may also be used. FIG. 12 is a view illustrating a variation of the rotor illustrated in FIG. 1. The rotor 5-1 illustrated in FIG. 12 includes the magnet insertion holes 21 and the permanent magnets 19 each having a linear shape.

Two of the permanent magnets 19 are inserted in each of the magnet insertion holes 21 each having a V-shape. Two of the permanent magnets 19 form one magnetic pole.

Specifically, the magnet insertion holes 21 are each formed in a V-shape that opens in a direction from the rotational centerline CL toward the rotor outer circumferential surface 5a. That is, the magnet insertion holes 21 each have a shape projecting toward the center of the rotor 5-1. The magnet insertion holes 21 are disposed concyclically.

The permanent magnets 19 each having a plate shape are inserted in the magnet insertion holes 21. A pair of permanent magnets 19 is inserted in each of the magnet insertion holes 21, and one pair of the permanent magnets 19 constitutes one magnetic pole.

A pair of recess portions 61 is formed on the hole outer side surface of the magnet insertion hole 21. One recess portion 61 of the pair of recess portions 61 is located on one end side of the hole outer side surface, while the other recess portion 61 of the pair of recess portions 61 is located on another end side of the hole outer side surface.

Each of the pair of recess portions 61 extends toward the magnetic pole centerline MC. The bottom portions 61b of the pair of recess portions 61 are each formed in an arc shape. The gap 61a, which is a non-magnetic region, is formed between each of the recess portions 61 and the outer side surface of permanent magnet 19. The gap 61a is a space enclosed by the inner circumferential surface of the corresponding recess portion 61 and the outer side surface of the permanent magnets 19.

As described above, the permanent-magnet-embedded electric motor 1 of the first embodiment includes an annular stator, and an annular rotor iron core disposed on an inner side of the stator. The rotor iron core has a plurality of magnet insertion holes aligned in a circumferential direction of the stator. A sectional shape of each of the magnet insertion holes is a shape projecting toward a center of the stator. Each of the magnet insertion holes has a pair of recess portions on an outer side surface in a radial direction of the stator. The recess portions of each of the magnet insertion holes are respectively disposed on one end portion and on another end portion of the outer side surface. The one end portion and the another end portion are aligned in the circumferential direction of the stator. The permanent-magnet-embedded electric motor 1 also includes a plurality of permanent magnets respectively inserted in the magnet insertion holes. The depth of each of the recess portions is in a range from 10% to 40% of a thickness of each of the permanent magnets in the radial direction of the stator. This configuration can provide the permanent-magnet-embedded electric motor 1 capable of avoiding reduction in the amounts of the magnetic flux of the permanent magnets 19, while still achieving high efficiency.

### Second Embodiment

Next, a compressor incorporating the permanent-magnet-embedded electric motor 1 according to the first embodiment will be described.

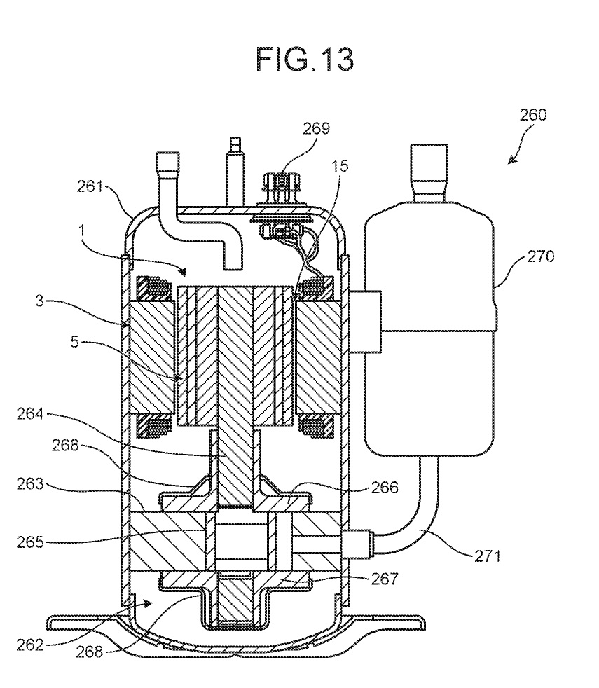

FIG. 13 is a longitudinal cross-sectional view of a compressor according to a second embodiment of the present invention. The compressor of FIG. 13 is a rotary compressor 260 incorporating the permanent-magnet-embedded electric motor of the first embodiment.

The rotary compressor 260 includes, in a sealed container 261, the permanent-magnet-embedded electric motor 1 of the first embodiment as a motor element, and also includes a compression element 262. Although not illustrated, refrigerator oil for lubricating the sliding portions of the compression element 262 is stored in a bottom portion of the sealed container 261.

The compression element 262 mainly includes: a cylinder 263 installed in a vertically sandwiched manner; a rotary shaft 264, which is the shaft 13, rotated by the permanent-magnet-embedded electric motor 1; a piston 265 fitted to the rotary shaft 264 by insertion; vanes (not illustrated) dividing the inside the cylinder 263 into a suction side and a compression side; a pair of an upper frame 266 and a lower frame 267 to which the rotary shaft 264 is rotatably inserted therein, and occludes the axial end surfaces of the cylinder 263; and mufflers 268 respectively attached to the upper frame 266 and to the lower frame 267.

The stator 3 of the permanent-magnet-embedded electric motor 1 is directly attached to, and held by, the sealed container 261 by shrink fitting, cooling fitting, or welding. The coils of the stator 3 are supplied with power through a glass terminal 269 fixed onto the sealed container 261.

The rotor 5 is disposed radially inside the stator 3 with the clearance 15 interposed therebetween, and is rotatably held by a bearing of the compression element 262 via the rotary shaft 264 disposed in a center portion of the rotor 5. The bearing corresponds to the upper frame 266 and the lower frame 267.

An operation of the rotary compressor 260 will next be described.

Refrigerant gas supplied from an accumulator 270 is sucked into the cylinder 263 through an inlet pipe 271 fixedly attached to the sealed container 261.

Energization of the inverter causes the permanent-magnet-embedded electric motor 1 to rotate, and thus the piston 265 engaged with the rotary shaft 264 rotates in the cylinder 263, thereby compressing the refrigerant in the cylinder 263.

The refrigerant passes through the mufflers and rises upward in the sealed container 261. In this process, the refrigerator oil has been mixed with the refrigerant compressed.

Upon passing through the air holes provided in the rotor iron core, this mixture of the refrigerant and the refrigerator oil is promoted to separate into the refrigerant and the refrigerator oil, and the refrigerator oil can thus be prevented from flowing into an outlet pipe. In this manner, the compressed refrigerant is supplied to the high-pressure side of the refrigeration cycle through the outlet pipe attached to the sealed container 261.

The refrigerant used for the rotary compressor 260 is conventionally-existing R410A and R407C, which are hydrofluorocarbon (HFC)-based refrigerants, or R22, which is a hydrochlorofluorocarbon-based refrigerant. However, a refrigerant having a low global warming potential (hereinafter referred to as “low GWP”) or a refrigerant other than a low GWP refrigerant may also be used. From a viewpoint of prevention of global warming, a low GWP refrigerant is preferred. Typical examples of low GWP refrigerant include the refrigerants listed in (1) to (3) below.

(1) HFO-1234yf (CF₃CF═CH₂), which is an example of halogenated hydrocarbon having a carbon-carbon double bond in the composition. HFO stands for HydroFluoro-Olefin. The term “olefin” refers to an unsaturated hydrocarbon having one double bond. HFO-1234yf has a GWP of 4.

(2) R1270 propylene, which is an example of hydrocarbon having a carbon-carbon double bond in the composition. R1270 propylene has a GWP of 3, which is lower than the GWP of HFO-1234yf. However, R1270 propylene is more combustible than HFO-1234yf.

(3) A mixture of HFO-1234yf and R32, which is an example of a mixture containing either a halogenated hydrocarbon having a carbon-carbon double bond in the composition or a hydrocarbon having a carbon-carbon double bond in the composition. Because of a low pressure refrigerant, HFO-1234yf produces a large pressure loss, and tends to reduce the performance of the refrigeration cycle, in particular, of the evaporator. Thus, a mixture containing R32 or R41, which is a higher pressure refrigerant than HFO-1234yf, is practically preferred.

Note that the compressor of the second embodiment is not limited to a rotary compressor, and may also be a compressor other than a rotary compressor (e.g., a scroll compressor or a hermetic compressor).

The rotary compressor 260 configured as described above provides an advantage similar to that of the first embodiment by the use of the permanent-magnet-embedded electric motor 1 described above.

### Third Embodiment

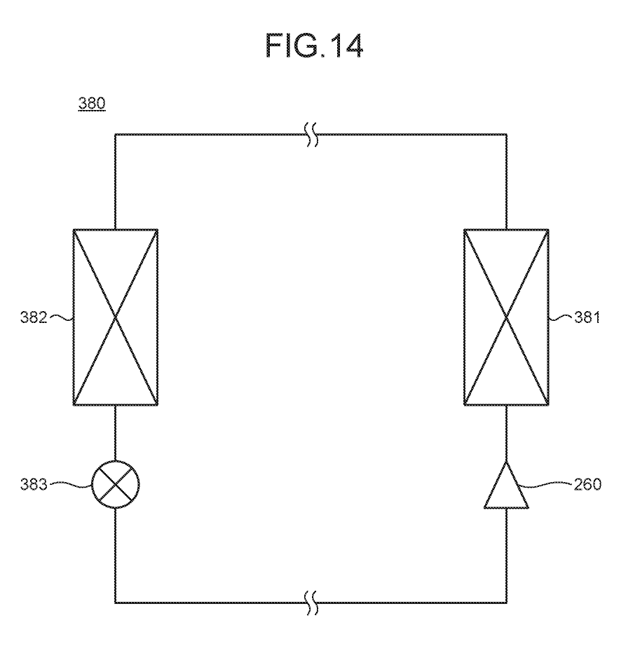

FIG. 14 is a configuration diagram of a refrigeration and air-conditioning apparatus according to a third embodiment of the present invention. In the third embodiment, a refrigeration and air-conditioning apparatus 380 incorporating the rotary compressor 260 according to the second embodiment will be described.

The refrigeration and air-conditioning apparatus 380 mainly includes: the rotary compressor 260; a condenser 381 that exchanges heat between high-temperature, high-pressure compressed refrigerant gas and air to condense the refrigerant gas into liquid refrigerant; an expander device 383 for expanding the liquid refrigerant to provide low-temperature, low pressure liquid refrigerant; and an evaporator 382 that absorbs heat from the low-temperature, low pressure liquid refrigerant to transform the liquid refrigerant to low-temperature, low pressure gas refrigerant.

The rotary compressor 260, the condenser 381, the evaporator 382, and the expander device 383 are connected to one another by refrigerant pipes to form a refrigeration circuit. The use of the rotary compressor 260 enables the high efficiency, high power refrigeration and air-conditioning apparatus 380 to be provided.

Note that the refrigeration circuit of the refrigeration and air-conditioning apparatus 380 includes at least the condenser 381, the evaporator 382, and the expander device 383; and the configuration of other components is not particularly limited.

The configurations described in the foregoing embodiments are merely examples of various aspects the present invention. These configurations may be combined with a known other technology, and moreover, a part of such configurations may be omitted and/or modified without departing from the spirit of the present invention.

1. A permanent-magnet-embedded electric motor comprising:
an annular stator;
an annular rotor iron core disposed on an inner side of the stator and including a plurality of magnet insertion holes aligned in a circumferential direction of the stator, a sectional shape of each of the magnet insertion holes being a shape projecting toward a center of the stator, each of the magnet insertion holes including a pair of recess portions on an outer side surface in the radial direction of the stator, the recess portions of each of the magnet insertion holes being respectively disposed at one end portion and another end portion of the outer side surface, the one end portion and the another end portion being aligned in the circumferential direction of the stator; and
a plurality of permanent magnets inserted into the magnet insertion holes, respectively, wherein
in a state the permanent magnet is inserted in the magnet insertion hole, and when the outer side surface of the permanent magnet exists facing the recess portions, a depth of the recess portions represents the distance between the bottom portion of the recess portions and the outer side surface of the permanent magnet, the depth of each of the recess portions is 10% to 40% of a thickness of each of the permanent magnets in the radial direction of the stator.

2. The permanent-magnet-embedded electric motor according to claim 1, wherein a gap is formed between each of the pair of recess portions and each of the permanent magnets while the permanent magnets are respectively inserted in the magnet insertion holes.

3. The permanent-magnet-embedded electric motor according to claim 1, wherein each of the permanent magnets is a ferrite magnet or a rare earth magnet.

4. A compressor comprising, in a sealed container:
a motor; and
a compression element,
wherein the motor is the permanent-magnet-embedded electric motor according to claim 1.

5. A refrigeration and air-conditioning apparatus comprising:
the compressor according to claim 4 as a component of a refrigeration circuit.

6. The permanent-magnet-embedded electric motor according to claim 2, wherein each of the permanent magnets is a ferrite magnet or a rare earth magnet.

7. A compressor comprising, in a sealed container:
a motor; and
a compression element,
wherein the motor is the permanent-magnet-embedded electric motor according to claim 2.

8. A compressor comprising, in a sealed container:
a motor; and
a compression element,
wherein the motor is the permanent-magnet-embedded electric motor according to claim 3.

9. A compressor comprising, in a sealed container:
a motor; and
a compression element,
wherein the motor is the permanent-magnet-embedded electric motor according to claim 6.

10. A refrigeration and air-conditioning apparatus comprising:
the compressor according to claim 7 as a component of a refrigeration circuit.

11. A refrigeration and air-conditioning apparatus comprising:
the compressor according to claim 8 as a component of a refrigeration circuit.

12. A refrigeration and air-conditioning apparatus comprising:
the compressor according to claim 9 as a component of a refrigeration circuit.
